(19) United States
(12) Patent Application Publication
(10) Pub. No.: US 2019/0354386 A1
(43) Pub. Date: Nov. 21, 2019

(54) SYSTEM AND METHOD FOR EXECUTING VIRTUALIZATION SOFTWARE OBJECTS WITH DYNAMIC STORAGE

(71) Applicant: International Business Machines Corporation, Armonk, NY (US)

(72) Inventors: Zvi Cahana, Nahariya, IL (US); Etai Lev-Ran, Nofit (IL); Or Ozeri, Modlin (IL); Idan Zach, Givat Ela (IL)

(21) Appl. No.: 15/984,429

(22) Filed: May 21, 2018

(51) Int. Cl. G06F 9/455; G06F 9/50

(52) U.S. Cl. CPC G06F 9/455; G06F 9/5016; G06F 9/5027

(57) ABSTRACT

A system for executing one or more operating-system-level virtualization software objects (virtualization containers), comprising at least one controller hardware processor, adapted to: receive a request to connect one or more target virtualization containers, executed by at least one target hardware processor, to at least one digital storage connected to the at least one target hardware processor via at least one data communication network interface; and instruct execution of one or more management virtualization containers on the at least one target hardware processor, such that executing the one or more management virtualization containers configures the one or more target virtualization containers to direct at least one access to the at least one file system of the one or more target virtualization containers to the at least one digital storage.

### BACKGROUND

The present invention, in some embodiments thereof, relates to a system for executing operating system level virtualization objects and, more specifically, but not exclusively, to using dynamic digital storage in a system executing operating system level virtualization objects.

The term “cloud computing” refers to delivering one or more hosted services, often over the Internet. Some hosted services provide infrastructure. Examples of a hosted service providing infrastructure delivered over the Internet are digital storage, networking, and a compute resource on which an application workload may execute such as a physical machine, a virtual machine (VM) or a virtual environment (VE). Cloud computing enables an entity such as a company to consume the one or more hosted services as a utility, in a pay-as-you-go model shifting the traditional capital expense (CAPEX) and operational expense (OPEX) cost structure to a pure OPEX cost structure. With the operational flexibility this model may offer, there is an increase in the amount of systems implemented using cloud computing. Possible advantages of a cloud implementation of a system compared to a system comprising dedicated digital storage devices and dedicated hardware processing resources include reduced cost of digital storage and computing resources, simpler storage management, easier expansion and shrinking of the system, better backup and recovery, and decreased Information Technology (IT) maintenance costs.

Cloud computing helps reduce costs by sharing one or more pools of discrete resources between one or more customers (typically referred to as “tenants”) of a cloud computing service. In some cloud computing service implementations some resources of the one or more pools of discrete resources are assigned to a tenant for the tenant's exclusive use. In some cloud computing service implementations the one or more pools of discrete resources are shared by one or more tenants, each running one or more software application workloads, with the cloud computing service providing isolation between the one or more tenants. When sharing a discrete resource amongst one or more tenants, full isolation between the tenants is paramount.

One possible means of isolating between the one or more software applications is by using virtual machines (VMs). VMs are created on top of a virtual machine monitor (also known as a hypervisor), which is installed on a host operating system. Another possible means of isolating between the one or more software applications is by using operating-system-level virtualization software objects, where an operating system kernel allows the existence of multiple isolated user-space instances for running the one or more software applications. Each of these isolated user-space instances is an operating-system-level virtualization software object, also known as a container or a virtualization container, each running one or more software programs or applications (software processes) in isolation from other software programs. A container directly runs on a host operating system (OS) or on a container platform engine running directly on the host OS. In some implementations, the container does not execute a guest OS of its own. A program running inside a container can only see the container's contents and devices assigned to the container. The host OS provides isolation and does resource allocation to each of the individual containers running on the host OS. Examples of container technologies are Docker, FreeBSD jails, and CoreOS rkt. Another example of container technologies is any technology compliant with the Open Container Initiative (OCI).

Orchestration refers to using programming technology to automate processes of configuration, management and interoperability of disparate computer systems, applications and services, for example management of interconnections and interactions among a plurality of software application workloads on a cloud infrastructure. Some orchestration frameworks, for example Kubernetes, Puppet Enterprise, and Docker Swarm, focus on connecting one or more automated tasks, for example one or more software programs or virtualization containers, into a cohesive workflow to accomplish a goal. Orchestration may comprise provisioning one or more resources, and enforcing an access policy to the one or more resources. Some examples of a provisioned resource are digital storage and networking,

### SUMMARY

It is an object of the present invention to provide a system and a method for using dynamic digital storage in a system executing operating system level virtualization objects.

The foregoing and other objects are achieved by the features of the independent claims. Further implementation forms are apparent from the dependent claims, the description and the figures.

According to a first aspect of the invention, a system for executing one or more operating-system-level virtualization software objects (virtualization containers) comprises at least one controller hardware processor, adapted to: receive a request to connect one or more target virtualization containers, executed by at least one target hardware processor, to at least one digital storage connected to the at least one target hardware processor via at least one data communication network interface; and instruct execution of one or more management virtualization containers on the at least one target hardware processor, such that executing the one or more management virtualization containers configures the one or more target virtualization containers to direct at least one access to the at least one file system of the one or more target virtualization containers to the at least one digital storage.

According to a second aspect of the invention, a computer implemented method for executing one or more operating-system-level virtualization software objects (virtualization containers) comprises: receiving a request to connect one or more target virtualization containers, executed by at least one target hardware processor, to at least one digital storage connected to the at least one target hardware processor via at least one data communication network interface; and instructing execution of one or more management virtualization containers on the at least one target hardware processor, such that executing the one or more management virtualization containers configures the one or more target virtualization containers to direct at least one access to the at least one file system of the one or more target virtualization containers to the at least one digital storage.

With reference to the first and second aspects, in a first possible implementation of the first and second aspects of the present invention, executing the one or more management virtualization containers initiates execution by the at least one target hardware processor of at least one storage attachment software object for communication between the one or more target virtualization containers and the at least one digital storage. Using execution of one or more management virtualization containers to initiate execution of at least one storage attachment software object allows attachment of new storage without disrupting execution of the one or more target virtualization containers, thus reducing degradation in one or more services provided by the one or more virtualization containers. Optionally, the at least one storage attachment software object is selected from a group consisting of: a device driver software object, and a storage management software object.

With reference to the first and second aspects, in a second possible implementation of the first and second aspects of the present invention, the at least one digital storage is selected from a group consisting of: a storage area network, a network attached storage, a hard disk drive, a partition on a hard disk drive, an optical disk, and a solid state storage. Optionally, the at least one target hardware processor accesses the at least one digital storage using a protocol selected from a group consisting of: Small Computer Systems Interface (SCSI), Internet Small Computer Systems Interface (iSCSI), Hyper Small Computer Systems Interface, Serial Advanced Technology Attachment (SATA), Advanced Technology Attachment over Ethernet (AoE), Network File System (NFS), Ceph File System (CephFS), Ceph RADOS Block Device (RBD), Gluster GlusterFS, Non-Volatile Memory Express (NVMe), Non-Volatile Memory Express over Fibre Channel (NVMe over FC), and Fibre Channel Protocol (FCP).

With reference to the first and second aspects, in a third possible implementation of the first and second aspects of the present invention, the at least one controller hardware processor is further adapted to: receive a request to disconnect the one or more target virtualization containers from the at least one digital storage; instruct the one or more management virtualization containers to disconnect the one or more target virtualization containers from the at least one digital storage by configuring the one or more target virtualization containers to decline directing at least one other access to the at least one file system of the one or more target virtualization containers to the at least one digital storage; and instruct termination of execution of the one or more management virtualization containers. Using termination of one or more management virtualization containers to disconnect at least one digital storage may facilitate removal of digital storage without disrupting execution of the one or more target virtualization containers, thus reducing degradation in one or more services provided by the one or more virtualization containers.

With reference to the first and second aspects, or the third implementation of the first and second aspects, in a fourth possible implementation of the first and second aspects of the present invention, configuring the one or more virtualization containers to decline directing the at least one other access comprises instructing the one or more target virtualization containers to execute a system call for unmounting a digital storage. Optionally, configuring the one or more virtualization containers to decline directing the at least one other access comprises instructing execution of at least one other system call of an operating system of the target host for unmounting a digital storage. Using system calls of the target host's operating system may reduce degradation of the one or more services provided by the one or more target virtualization containers while configuring the one or more target virtualization containers.

With reference to the first and second aspects, in a fifth possible implementation of the first and second aspects of the present invention, executing the one or more management virtualization containers configures the one or more target virtualization containers by executing in the one or more management virtualization containers at least one process for configuring the one or more target virtualization containers. Using at least one process executed in the one or more management virtualization containers may reduce degradation of the one or more services provided by the one or more target virtualization containers while configuring the one or more target virtualization containers. Optionally, execution of the one or more management virtualization containers is initiated by a virtualization container manager executed by the at least one target hardware processor, and executing the one or more management virtualization containers configures the one or more target virtualization containers by before executing the one or more management virtualization containers the virtualization container manager executing a plurality of modification computer instructions for configuring the one or more target virtualization containers. Optionally, executing the one or more management virtualization containers comprises executing one or more system calls of an operating system of the target host for mounting a digital storage.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic block diagram of an exemplary system, according to some embodiments of the present invention;

FIG. 2 is a flowchart schematically representing an optional flow of operations for adding a digital storage, according to some embodiments of the present invention;

FIG. 3 is a flowchart schematically representing an optional flow of operations on a target host, according to some embodiments of the present invention; and

FIG. 4 is a flowchart schematically representing an optional flow of operations for removing a digital storage, according to some embodiments of the present invention.

### DETAILED DESCRIPTION

The present invention, in some embodiments thereof, relates to a system for executing operating system level virtualization objects and, more specifically, but not exclusively, to using dynamic digital storage in a system executing operating system level virtualization objects.

For brevity, henceforth the term “host” means an instance of an operating system executed by a physical machine, a VM or a VE.

Some applications are designed having one or more tightly coupled virtualization containers (sometimes called a pod), co-located on a common host and whose execution is co-scheduled such that the one or more virtualization containers of a pod are scheduled to run together, in parallel to each other. Some container orchestration frameworks provide means for the one or more software applications running inside the virtualization container to access digital storage by configuring the host and the virtualization container's file system. Examples of digital storage are a storage area network, a network attached storage, a hard disk drive, a partition on a hard disk drive, an optical disk and a solid state storage. Attaching storage refers to creating a logical connection between a host and a digital storage, whether the digital storage is electrically attached to a hardware processor (direct attachment), such as a hard disk driver, and whether the digital storage is connected to the hardware processor over a network, such as a storage area network and a network attached storage. Communication protocols between a host and digital storage include, but are not limited to, Small Computer Systems Interface (SCSI), Internet Small Computer Systems Interface (iSCSI), Hyper Small Computer Systems Interface (HyperSCSI) and Advanced Technology Attachment over Ethernet (AoE). Attaching may comprise executing on the hardware processor one or more storage attachment software objects for communicating with the digital storage, for example a device driver or a storage management driver. Mounting refers to instructing an operating system how to logically map a directory structure to a digital storage device, such that some accesses to the file system by a software application are directed to the digital storage, via the one or more storage attachment software objects.

For brevity, henceforth the term “pod” refers to one or more virtualization containers co-located on a host and co-scheduled for execution, and the term “executing a virtualization container” means executing the one or more software processes of the virtualization container. Executing a pod refers to executing the one or more virtualization containers of the pod.

It is common practice for a definition of a container or of a pod to include specification of the container or pod's required digital storage. When a pod definition specifies requirement for a digital storage, a container orchestration framework for executing the pod, after selecting a host to execute the pod and prior to instructing the host to execute the pod, typically attaches the digital storage to the host selected to execute the pod and mounts the digital storage in the one or more virtualization containers of the pod, that is maps an access point in a file system of each of the one or more virtualization containers of the pod to the digital storage. A software application running in a virtualization container of the pod may access the storage by accessing the virtualization container's file system.

There may be a need to add digital storage to a running pod, or to modify a pod's storage configuration. For example, in a pod implementing a service where the storage is selected according to dynamic configuration parameters, or when additional storage is needed, such as extending a database's capacity. Other examples for a need to modify a pod's storage configuration are replacing a malfunctioning disk device and adding additional static content to be served by a web server. Existing container orchestration frameworks provide means for defining storage requirements when the container or pod is created. Changing a pod's storage requires, in these existing frameworks, termination of the pod's execution and deletion of the pod from the host executing the pod, modifying the pod's definition, and recreation and re-execution of the modified pod. This prevents dynamic addition and changes to storage without interrupting all services provided by the one or more software applications running in the pod.

To allow dynamically adding a new storage to an executing target pod comprising one or more executing target virtualization containers, the current invention proposes creating a management pod comprising one or more management virtualization containers and requiring the new storage, executing the management pod on a host executing the target pod and granting the target pod access to the new storage. According to some embodiments of the present invention, a container orchestration framework selects the target pod's host to execute the management pod, and instructs the selected host to create and execute the management pod. Prior to executing the management pod, in such embodiments the target pod's host attaches itself to the new storage by executing one or more storage attachment software objects. In addition, in such embodiments execution of the management pod on the target pod's host configures a mapping between one or more filesystems of the one or more target virtualization containers and the new storage. Thus, executing the management pod, requiring the new storage, on the target pod's host may be used to instigate attachment of the target pod's host to the new storage without disrupting execution of the one or more applications running in the target pod. After the target pod's host is attached to the new storage, the new storage may be made available for access by the one or more software applications, running in the target pod, by configuring a mapping between the one or more filesystems of the one or more target virtualization containers and the new storage. Configuring the mapping may be done without disrupting execution of any software application that does not require the new storage, reducing total downtime of one or more services provided by the target pod and thus reducing degradation in the one or more services provided by the target pod. Optionally, the mapping does not disrupt any of the services provided by the target pod. In addition, by avoiding the need to stop and delete the target pod from the target pod's host, the present invention may reduce loss of cached information, further reducing degradation in service provided by the target pod.

Optionally, the present invention allows dynamic removal of dynamically added storage by instructing termination of the management pod. In such embodiments, the management pod is adapted, upon termination, to remove the mapping between the one or more filesystems of the one or more target virtualization containers and the new storage. In addition, upon termination of the management pod's execution, the container orchestration framework optionally instructs termination of execution of the one or more storage attachment software objects. As detaching the new storage from the target pod's host does not require terminating execution of the target pod according to some embodiments of the present invention, in such embodiments the present invention allows reducing downtime of one or more services provided by the target pod when removing digital storage.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

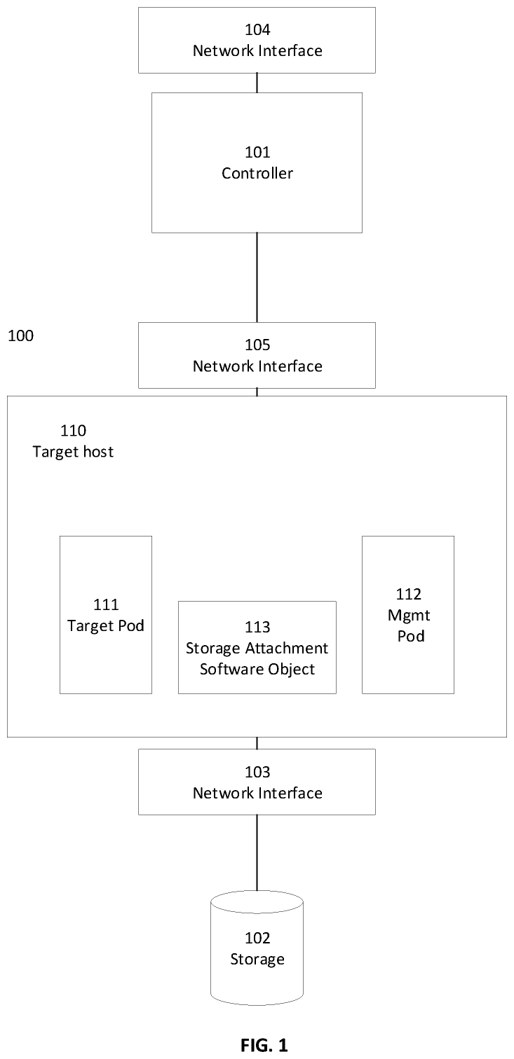

Reference is now made to FIG. 1, showing a schematic block diagram of an exemplary system 100, according to some embodiments of the present invention. In such embodiments, at least one controller hardware processor 101 is connected to at least one target hardware processor 110. For brevity, the term “controller” is used to mean at least one controller hardware processor, and the term “target host” is used to mean at least one target hardware processor. Optionally, controller 101 is connected to target host 110 by at least one first digital data communication network via at least one data communication network interface 105 connected to target host 110. Examples of a digital data communication network are a Local Area Network (LAN) such as an Ethernet network or a wireless network, and a Wide Area Network (WAN) such as the Internet. Optionally, controller 101 executes a container orchestration framework such as Kubernetes, Docker Swarm and Marathon. Optionally, target host 110 executes one or more target virtualization containers 111. Optionally, at least one digital storage 102 is connected to target host 110. Examples of a digital storage are a storage area network, a network attached storage, a hard disk drive, a partition on a hard disk drive, an optical disk, and a solid state storage. Optionally, at least one digital storage 102 is electrically connected to target host 110, for example when at least one digital storage 102 is a hard disk drive. Optionally, target host 110 is connected to at least one digital storage 102 by at least one second digital data communication network via at least one data communication network interface 103, for example when at least one digital storage 102 is a storage area network of a network attached storage. Optionally, at least one data communication network interface 103 is at least one data communication network interface 105. Optionally, target host 110 accesses at least one digital storage 102 using a storage communication protocol. Some examples of a storage communication protocol are SCSI, iSCSI, HyperSCSI, AoE, Serial Advanced Technology Attachment (SATA), Network File System (NFS), Ceph File System (CephFS), Ceph RADOS Block Device (RBD), Gluster GlusterFS, Non-Volatile Memory Express (NVMe), Non-Volatile Memory Express over Fibre Channel (NVMe over FC), and Fibre Channel Protocol (FCP).

To connect one or more virtualization container 111 to at least one digital storage 102, target host 110 optionally executes at least one storage attachment software object 113 and one or more management virtualization container 112. Optionally, controller 101 is connected to at least one third data communication network interface 104 for receiving one or more requests to add or remove digital storage.

For brevity, the term “target pod” means “one or more target virtualization containers”, and the term “management pod” means “one or more management virtualization containers”.

To dynamically add digital storage to one or more executing virtualization containers, system 100 implements in some embodiments the following optional method.

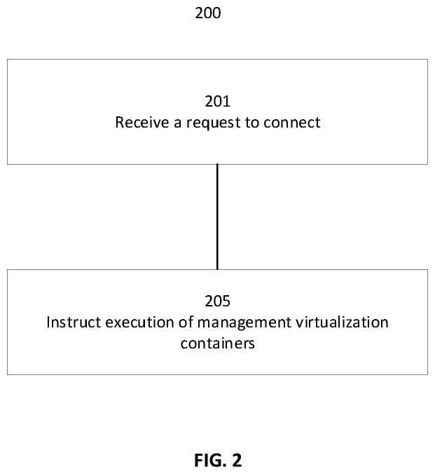

Reference is now made also to FIG. 2, showing a flowchart schematically representing an optional flow of operations 200 for adding a digital storage, according to some embodiments of the present invention. In such embodiments, controller 101 receives in 201 a request to connect target pod 111 to at least one digital storage 102. Optionally, controller 101 receives the request to connect via at least one data communication interface 104. Optionally, controller 101 implements HyperText Transfer Protocol (HTTP) for receiving the request to connect. Optionally, controller 101 implements a Representational State Transfer (REST) interface for receiving the request to connect. Optionally, controller 101 implements a command line interface (CLI) for receiving the request to connect. Optionally, the request to connect comprises digital data identifying one or more of: target pod 111, at least one digital storage 102, a volume name within target pod 111, and mount information in one or more file systems of target pod 111. Optionally, the target pod is identified by a Universally Unique Identifier (UUID) of the target pod or of at least one of the target pod's one or more virtualization containers. Optionally, controller 101 identifies target host 110 as a host executing target pod 111, and generates one or more virtualization container definition files defining one or more virtualization containers having a requirement for at least one digital storage 102 and having at least one process for configuring target pod 111. In 205, controller 110 optionally instructs execution of management pod 112 on target host 110, for example by instructing target host 110 to create and execute management pod 112 according to the one or more virtualization container definition files. Optionally, executing management pod 112 on target host 110 configures target pod 111 to direct at least one access to at least one file system of target pod 111 to at least one digital storage 102.

To configure target pod 111 to have access to at least one digital storage 102 by executing management pod 112, target host 110 may implement the following optional method.

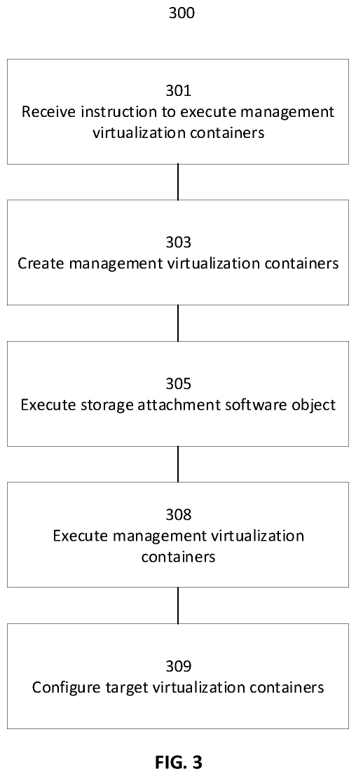

Reference is now made also to FIG. 3, showing a flowchart schematically representing an optional flow of operations 300 on a target host, according to some embodiments of the present invention. In such embodiments, target host 110 receives in 301 an instruction to execute management pod 112, for example by receiving the one or more virtualization container definition files, and in 303 creates management pod 112. When the one or more virtualization container definition files include an identification of at least one digital storage 102, target host 110 optionally executes in 305 one or more storage attachment software objects 113, for communicating with at least one digital storage 102 and creating a logical connection between target host 110 and at least one digital storage 102. Examples of a storage attachment software object are a device driver and a storage management driver. Optionally, at least on storage attachment software 113 implements a storage communication protocol, for example SCSI, iSCSI, HyperSCSI, AoE, Serial Advanced Technology Attachment (SATA), Network File System (NFS), Ceph File System (CephFS), Ceph RADOS Block Device (RBD), Gluster GlusterFS, Non-Volatile Memory Express (NVMe), Non-Volatile Memory Express over Fibre Channel (NVMe over FC), or Fibre Channel Protocol (FCP).

In 308 target host 110 optionally executes management pod 112, optionally resulting in configuring in 309 target pod 111 to have access to at least one digital storage 102 such that at least one access to at least one file system of target pod 111 is directed to at least one digital storage 102. In some embodiments management pod 112 runs one or more processes for configuring target pod 111. Optionally, target host 110 executes a virtualization container manager for creating and executing one or more virtualization containers on target host 110. Optionally, the one or more processes for configuring target pod 111 invoke a remote procedure call of the virtualization container manager. Optionally, the one or more virtualization container definition files include one or more modification computer instructions for the virtualization container manager to execute before executing the management pod in order to configure target pod 111. Optionally, the one or more processes for configuring target pod 111 are defined as special life-cycle processes in a life cycle of a virtualization container, for example to be executed prior to executing a main process of the virtualization container. Optionally the one or more processes for configuring target pod 111 are a main process of a virtualization container. Optionally, configuring target pod 111 comprises instructing target pod 111 to execute a system call for mounting at least one digital storage 102 to one or more file systems of target pod 111. Optionally, configuring target pod 111 configures instructing execution of one or more system calls of an operating system of target host 110 to mount digital storage 102 to the one or more file systems of target pod 111.

In some embodiments, to dynamically remove digital storage from one or more executing virtualization containers, system 100 implements the following optional method.

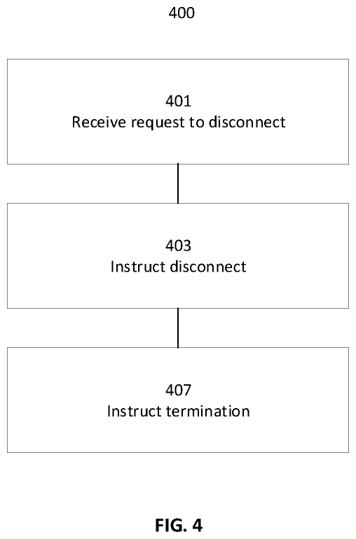

Reference is now made also to FIG. 4, showing a flowchart schematically representing an optional flow of operations 400 for removing a digital storage, according to some embodiments of the present invention. In such embodiments, controller 101 receives in 401 a request to disconnect target pod 111 from at least one digital storage 102. Optionally, controller 101 implements HyperText Transfer Protocol (HTTP) for receiving the request to disconnect. Optionally, controller 101 implements a Representational State Transfer (REST) interface for receiving the request to disconnect. Optionally, controller 101 implements a command line interface (CLI) for receiving the request to disconnect. Optionally, the request to disconnect comprises digital data identifying one or more of: target pod 111, at least one digital storage 102, a volume name within target pod 111, and mount information in one or more file systems of target pod 111. Controller 101 optionally identifies target host 110 as executing target pod 111 and optionally instructs target host 110 in 403 to disconnect target pod 111 from at least one digital storage 102, and in 407 optionally instructs target host 110 to terminate execution of management pod 112. Upon configuration of target pod 111 to disconnect from at least one digital storage 102, target pod 111 declines directing at least one other access to at least one file system of target pod 111 to at least one digital storage 102, i.e. when at least one software process of at least one target pod 111 makes the at least one other access to the at least one file system of target pod 111 that may have been directed to at least one digital storage 102, target pod 111 may not direct the at least one other access to at least one digital storage 102. For example, a system call executed by target pod 111 upon making the at least one other access may return with a value indicating that a storage is not available. Optionally, the instruction to terminate execution of management pod 112 comprises the instruction to disconnect target pod 111 from at least one digital storage 102. To disconnect target pod 111 from at least one digital storage 102, target host 110 optionally invokes a remote procedure call of the virtualization container manager. Optionally, the one or more virtualization container definition files include one or more other modification computer instructions for the virtualization container manager to execute when terminating execution of the management pod in order to configure target pod 111 to disconnect from at least one digital storage 102. Optionally, configuring target pod 111 to disconnect from at least one digital storage 102 comprises executing at least one termination process executed upon terminating execution of a main process of a virtualization container. Optionally a main process of a virtualization container of the management pod configures target pod 111 to disconnect from at least one digital storage 102. Optionally, configuring target pod 111 to disconnect from at least one digital storage 102 comprises instructing target pod 111 to execute at least one system call for unmounting at least one digital storage 102 from one or more file systems of target pod 111. Optionally, target host 110 executes at least one system call of the operating system of target host 110 for unmounting at least one digital storage 102 from the one or more file systems of target pod 111. Optionally, upon termination of execution of management pod 112, target host 110 terminates execution of at least one storage attachment software object.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant digital storage, storage attachment software, container orchestration frameworks and container execution frameworks will be developed and the scope of the terms “digital storage”, “storage attachment software”, “container orchestration framework” and “container execution framework” is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for executing one or more operating-system-level virtualization software objects (virtualization containers), comprising at least one controller hardware processor, adapted to:
receive a request to connect one or more target virtualization containers, executed by at least one target hardware processor, to at least one digital storage connected to the at least one target hardware processor via at least one data communication network interface; and
instruct execution of one or more management virtualization containers on the at least one target hardware processor, such that executing the one or more management virtualization containers configures the one or more target virtualization containers to direct at least one access to the at least one file system of the one or more target virtualization containers to the at least one digital storage.

2. The system of claim 1, wherein the at least one digital storage is selected from a group consisting of: a storage area network, a network attached storage, a hard disk drive, a partition on a hard disk drive, an optical disk, and a solid state storage.

3. The system of claim 1, wherein the at least one target hardware processor accesses the at least one digital storage using a protocol selected from a group consisting of: Small Computer Systems Interface (SCSI), Internet Small Computer Systems Interface (iSCSI), Hyper Small Computer Systems Interface, Serial Advanced Technology Attachment (SATA), Advanced Technology Attachment over Ethernet (AoE), Network File System (NFS), Ceph File System (CephFS), Ceph RADOS Block Device (RBD), Gluster GlusterFS, Non-Volatile Memory Express (NVMe), Non-Volatile Memory Express over Fibre Channel (NVMe over FC), and Fibre Channel Protocol (FCP).

4. The system of claim 1, wherein executing the one or more management virtualization containers initiates execution by the at least one target hardware processor of at least one storage attachment software object for communication between the one or more target virtualization containers and the at least one digital storage.

5. The system of claim 4, wherein the at least one storage attachment software object is selected from a group consisting of: a device driver software object, and a storage management software object.

6. The system of claim 1, wherein the at least one controller hardware processor is further adapted to:
receive a request to disconnect the one or more target virtualization containers from the at least one digital storage;
instruct the one or more management virtualization containers to disconnect the one or more target virtualization containers from the at least one digital storage by configuring the one or more target virtualization containers to decline directing at least one other access to the at least one file system of the one or more target virtualization containers to the at least one digital storage; and
instruct termination of execution of the one or more management virtualization containers.

7. The system of claim 1, wherein executing the one or more management virtualization containers configures the one or more target virtualization containers by executing in the one or more management virtualization containers at least one process for configuring the one or more target virtualization containers.

8. The system of claim 1, wherein execution of the one or more management virtualization containers is initiated by a virtualization container manager executed by the at least one target hardware processor; and
wherein executing the one or more management virtualization containers configures the one or more target virtualization containers by before executing the one or more management virtualization containers the virtualization container manager executing a plurality of modification computer instructions for configuring the one or more target virtualization containers.

9. The system of claim 1, wherein executing the one or more management virtualization containers comprises executing one or more system calls of an operating system of the target host for mounting a digital storage.

10. The system of claim 6, wherein configuring the one or more virtualization containers to decline directing the at least one other access comprises instructing the one or more target virtualization containers to execute a system call for unmounting a digital storage.

11. The system of claim 6, wherein configuring the one or more virtualization containers to decline directing the at least one other access comprises instructing execution of one or more other system calls of an operating system of the target host for unmounting a digital storage.

12. A computer implemented method for executing one or more operating-system-level virtualization software objects (virtualization containers), comprising:
receiving a request to connect one or more target virtualization containers, executed by at least one target hardware processor, to at least one digital storage connected to the at least one target hardware processor via at least one data communication network interface; and
instructing execution of one or more management virtualization containers on the at least one target hardware processor, such that executing the one or more management virtualization containers configures the one or more target virtualization containers to direct at least one access to the at least one file system of the one or more target virtualization containers to the at least one digital storage.
